(19) United States
(12) Patent Application Publication
(10) Pub. No.: US 2012/0162832 A1
(43) Pub. Date: Jun. 28, 2012

(54) ESD PROTECTION CIRCUIT FOR MULTI-POWERED INTEGRATED CIRCUIT

(75) Inventors: Wen-Tai Wang, Hsinchu County (TW); Ming-Jing Ho, Taipei City (TW)

(73) Assignee: GLOBAL UNICHIP CORP., Hsinchu City (TW)

(21) Appl. No.: 12/978,638

(22) Filed: Dec. 27, 2010

(51) Int. Cl. H02H 9/04

(52) U.S. Cl. 361/56

(57) ABSTRACT

For a multi-powered IC, an ESD protection circuit includes multiple voltage clamping circuits, each configured to provide a path for discharging an ESD transient current associated with a corresponding power supply.

### BACKGROUND OF THE INVENTION

1. Field of the Invention

The present invention is related to an ESD protection circuit, and more particularly, to an ESD protection circuit for multi-powered integrated circuits.

2. Description of the Prior Art

Electrostatic discharge (ESD) is a major source of reliability failures in integrated circuits (ICs). ESD arises when electrostatic charge accumulated on one object (for example a human body or a piece of equipment) is conducted onto a second object (for example a circuit board). This conduction of charge often results in damages to ICs, whether through electrical over-voltage stress or through thermal stress caused by large currents.

With recent progress in VLSI technology, the largely miniaturized ICs become more and more susceptible to ESD damage. Therefore, various ESD protection structures have been placed near input, output, or bi-directional I/O pins of ICs. Many of these protection structures use passive components such as series resistors and thick-oxide transistors. Another type of ESD structure uses an active transistor to safely shunt ESD transient current. Normally, ESD test procedures are required in order to characterize, determine, and classify ESD susceptibility of an ESD-sensitive (ESDS) device, such as an IC. These test procedures are based on three primary models of ESD events: human body model (HBM), machine model (MM), and charged device model (CDM). HBM simulates the ESD phenomenon wherein a charged body directly transfers its accumulated electrostatic charge to the device under test. MM or CDM simulates a more rapid and severe electrostatic discharge from a charged machine, fixture, or tool.

FIG. 1 is a diagram illustrating a prior art ESD protection circuit 100. The ESD protection circuit 100 includes a voltage clamping circuit 10 and diodes D1-D2. The voltage clamping circuit 10, biased by a positive power supply VDD and a ground supply GND, is turned off during normal powered operation. When a positive ESD zap or pulse is applied to, or is somehow coupled to, a power node PAD of an IC, the rapid rise in voltage on the power node PAD turns on the diode D1 and the voltage clamping circuit 10. The ESD transient current may thus be shunted to ground, thereby preventing the IC from possible ESD damages.

Conventional ESD protection structures, however, are effective primarily in devices with a single VDD power supply for digital signals. For IC's with mixed signals, i.e. digital and analog signals, multiple independent VDD power supply busses are required to accommodate the requirement of isolation between the various circuit functions. For adequate ESD protection in ICs with multiple VDD supplies so as to sustain higher and faster ESD transient currents in MM/CDM tests, there is a need for an ESD protection circuit which can provide a robust discharging mechanism in response to different positive ESD surges.

### SUMMARY OF THE INVENTION

The present invention provides an ESD protection circuit including a first voltage clamping circuit, a second voltage clamping circuit, a first path-controller and a second path-controller. The first voltage clamping circuit is biased by a first positive power supply and a first ground supply and configured to provide a first discharging path. The second voltage clamping circuit is biased by a second positive power supply and a second ground supply and configured to provide a second discharging path. The first path-controller is coupled between the power node and the first positive power supply of the first voltage clamping circuit for allowing a first ESD transient current to be shunted via the first discharging path, wherein the first ESD transient current is induced when a first voltage higher than the first positive power supply is presented at the power node. The second path-controller is coupled between the power node and the second positive power supply of the second voltage clamping circuit for allowing a second ESD transient current to be shunted via the second discharging path, wherein the second ESD transient current is induced when a second voltage higher than the second positive power supply is presented at the power node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art ESD protection circuit.

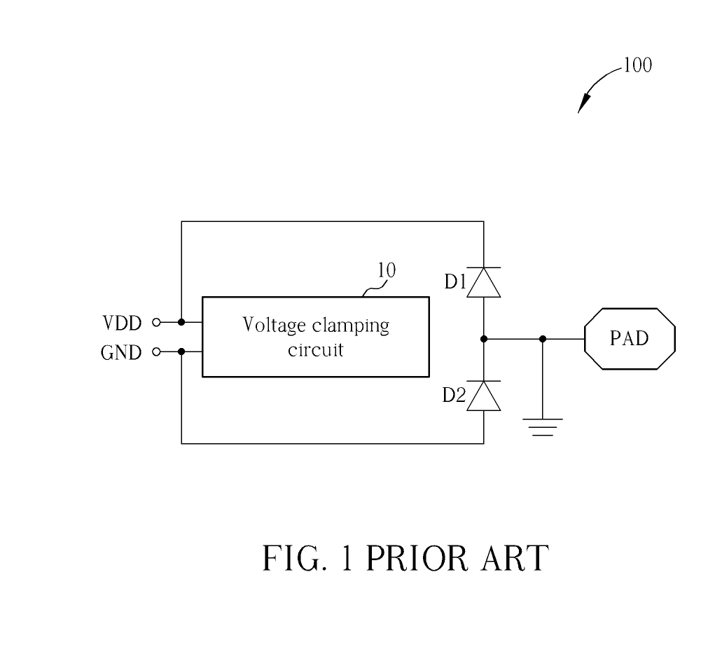

FIG. 2 is a diagram illustrating an ESD protection circuit according to the present invention.

FIG. 3 is a diagram illustrating an embodiment of a voltage clamping circuit in FIG. 2.

### DETAILED DESCRIPTION

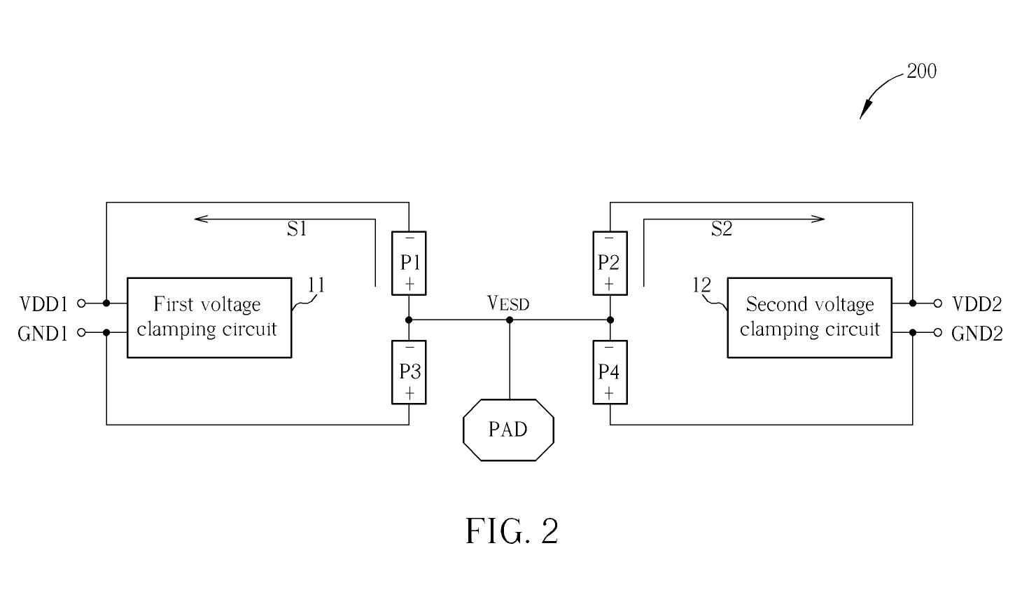

FIG. 2 is a diagram illustrating an ESD protection circuit 200 according to the present invention. The ESD protection circuit 200 includes a first voltage clamping circuit 11, a second voltage clamping circuit 12 and four path-controllers P1-P4. The first voltage clamping circuit 11, biased by a positive power supply VDD1 and a ground supply GND1, while the second voltage clamping circuit 12 is biased by a positive power supply VDD2 and a ground supply GND2. The first voltage clamping circuit 11 and the second voltage clamping circuit 12 are both turned off during normal powered operation. In the embodiment illustrated in FIG. 2, the values of VDD1 and VDD2 may be determined according to the IC which is configured to operate according to multiple VDD supplies. For example, VDD1 may be 2.5V and VDD2 may be 3.3V.

The path-controller P1 is a two-terminal device having a positive terminal coupled to a power node PAD of an IC and a negative terminal coupled to the VDD1 bus of the first voltage clamping circuit 11. The path-controller P2 is a two-terminal device having a positive terminal coupled to the power node PAD and a negative terminal coupled to the VDD2 bus of the second voltage clamping circuit 12. The path-controller P3 is a two-terminal device having a negative terminal coupled to the power node PAD and a positive terminal coupled to the GND1 bus of the first voltage clamping circuit 11. The path-controller P4 is a two-terminal device having a negative terminal coupled to the power node PAD and a positive terminal coupled to the GND2 bus of the second voltage clamping circuit 12. The path-controllers P1-P4 may be any two-terminal device which is configured to provide a low-impedance path when the voltage across its positive terminal and negative terminal exceeds its threshold voltage. Examples of such path-controllers include, but not limited to, diodes, metal-oxide-semiconductor (MOS) transistors, field oxide devices, bipolar junction transistors (BJTs), or silicon controlled rectifiers (SCRs).

In response to a positive ESD zap V_{ESD} presented at the power node PAD, the present ESD protection circuit 200 is configured to protect the IC from possible damages. When the ESD zap V_{ESD} is between VDD1 (for example 2.5V) and VDD2 (for example 3.3V), the path-controller P1 is forward-biased, allowing the ESD zap V_{ESD} to turn on the first voltage clamping circuit 11. The path-controller P2 and the voltage clamping circuit 12 remain off. The ESD transient current associated with the ESD zap V_{ESD} may thus be shunted to the GND1 bus along a path S1, thereby preventing the IC from possible ESD damages. When the ESD zap V_{ESD} is greater than VDD2, the path-controllers P1 and P2 are forward-biased, allowing the ESD zap V_{ESD} to turn on the voltage clamping circuits 11 and 12. The turned-on second voltage clamping circuit 12 provides another path S2 for discharging the ESD transient current associated with the ESD zap V_{ESD} to the GND2 bus. Therefore, the present invention may provide robust ESD protection with two discharging paths for ICs which operate according to two VDD supplies.

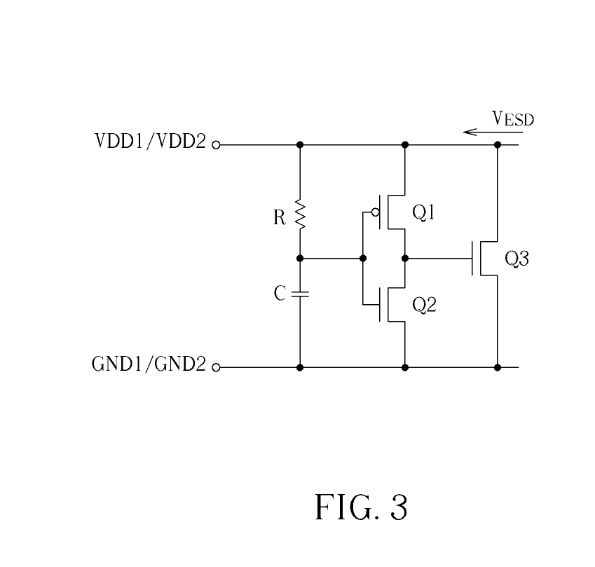

FIG. 3 is a diagram illustrating an embodiment of the voltage clamping circuit 11 or 12. In this embodiment, the voltage clamping circuit includes a capacitor C, a resistor R, a p-channel transistor Q1, an n-channel transistor Q2 and an n-channel shunt transistor Q3. During normal powered operation, the top plate of the capacitor C is charged to VDD1 or VDD2 through the resistor R. The high voltage on the gates of the transistors Q1-Q2 turns on the n-channel transistor Q2 and turns off the p-channel transistor Q1, causing the gate of the n-channel shunt transistor Q3 to be driven low. Therefore, the n-channel shunt transistor Q3 remains off during normal powered operation.

When the ESD zap V_{ESD} is applied to the power node PAD, or is somehow coupled to the power node PAD, the rapid voltage surge is transmitted to the VDD1 bus via the forward-biased path-controller P1 or to the VDD2 bus via the forward-biased path-controller P2, thereby causing the source of p-channel transistor Q1 to rise quickly. The gate of p-channel transistor Q1 does not rise as quickly because of the R-C time constant delay caused by charging of the capacitor C through resistor R. With its gate-to-source voltage increases in absolute value, the p-channel transistor Q1 is turned on, thereby charging the gate of the n-channel shunt transistor Q3 by connecting it to the VDD1/VDD2 bus. The n-channel shunt transistor Q3 is thus turned on by the high voltage applied to its gate, thereby shunting the ESD transient current from the VDD1/VDD2 bus to the GND1/GND2 bus.

The embodiment illustrated in FIG. 3 is only for illustrative purpose and does not limit the scope of the present invention. The voltage clamping circuits 11 and 12 may adopt various structures well-known to those skilled in the art. The ground supplies GND1 and GND2 are depicted as two separate buses, but may be connected to a common ground terminal in packages, printed circuited boards or chips in which the voltage clamping circuits 11 and 12 are integrated. Also, two voltage clamping circuits are used in order to provide ESD protection for an IC which operates according to two VDD supplies. However, more voltage clamping circuits may be used in order to provide ESD protection for an IC which operates according to more VDD supplies.

The present invention provides an ESD protection circuit which provides multiple paths for discharging ESD transient currents associated with different VDD supplies of an IC. Therefore, an IC using the present ESD protection circuit may have better ESD susceptibility, especially in MM/CDM tests.

Those skilled in the art will readily observe that numerous modifications and alterations of the device and method may be made while retaining the teachings of the invention.

What is claimed is:

1. An ESD (electrostatic discharge) protection circuit for use in
a multi-powered integrated circuit, comprising:
a first voltage clamping circuit biased by a first positive power supply and a first ground supply and configured to provide a first discharging path;
a second voltage clamping circuit biased by a second positive power supply and a second ground supply and configured to provide a second discharging path;
a first path-controller coupled between the power node and the first positive power supply of the first voltage clamping circuit for allowing a first ESD transient current to be shunted via the first discharging path, wherein the first ESD transient current is induced when a first voltage higher than the first positive power supply is presented at the power node; and
a second path-controller coupled between the power node and the second positive power supply of the second voltage clamping circuit for allowing a second ESD transient current to be shunted via the second discharging path, wherein the second ESD transient current is induced when a second voltage higher than the second positive power supply is presented at the power node.

2. The ESD protection circuit of claim 1 wherein:
the first voltage clamping circuit is turned on for providing the first discharging path when a voltage across the first path-controller exceeds a first threshold; and
the second voltage clamping circuit is turned on for providing the second discharging path when a voltage across the second path-controller exceeds a second threshold.

3. The ESD protection circuit of claim 1 wherein the first and the second path-controllers include diodes, metal-oxide-semiconductor (MOS) transistors, field oxide devices, bipolar junction transistors (BJTs), or silicon controlled rectifiers (SCRs).

4. The ESD protection circuit of claim 1 further comprising:
a third path-controller coupled between the power node and the first ground supply of the first voltage clamping circuit; and
a fourth path-controller coupled between the power node and the second ground supply of the second voltage clamping circuit.

5. The ESD protection circuit of claim 4 wherein the third and the fourth path-controllers include diodes, MOS transistors, field oxide devices, BJTs, or SCRs.

6. The ESD protection circuit of claim 1 wherein:
the first voltage clamping circuit is further configured to provide the first discharging path for shunting the second ESD transient current when the second positive power supply is higher than the first positive power supply.
